(19) United States
(12) Patent Application Publication
(10) Pub. No.: US 2008/0143494 A1
(43) Pub. Date: Jun. 19, 2008

(54) Assembly device which controls transmission of data signals with or without using wires

(75) Inventor: Chien-Kuo Yeh, Taipei City (TW)

Correspondence Address: Troxell Law Office PLLC;Suite 1404, 5205 Leesburg Pike, Falls Church, VA, 22041, US

(73) Assignee: Tai-Trans Trading Co., Ltd.

(21) Appl. No.: 11/637,889

(22) Filed: Dec. 13, 2006

(51) Int. Cl. G05B 11/01; G06F 3/038

(52) U.S. Cl. 340/310.12; 345/212

(57) ABSTRACT

An assembly device which controls transmission of data signals with or without using wires is composed of a control interface, a carrier wave module, and an output module. When the control interface carries out a control operation, a control instruction is transmitted through a carrier wave emission interface and a carrier wave receiving interface of the carrier wave module, and a voltage signal and a control signal are effectively transmitted through the output module, such that the control interface can effectively control a displaying device through the carrier wave module, to solve an issue that data signals cannot be transmitted without deploying an awkward wiring between the control interface and the displaying device.

### BACKGROUND OF THE INVENTION

(a) Field of the Invention

The present invention relates to an assembly device which controls transmission of data signals with or without using wires, and more particularly to an assembly device which is located between a control interface and an output module and utilizes a carrier wave of power line.

(b) Description of the Prior Art

As a popularity of use of power, our daily life and working environment are full of power equipment. For a user, if each one of the power equipment is to be assembled into an automatic or message transmission network, then other wirings should be deployed to accomplish; however, this method not only destroys an existing decoration, but also is a troublesome and complicated project.

Accordingly, how to eliminate the aforementioned problems is a technical issue to be solved by the inventor of present invention.

### SUMMARY OF THE INVENTION

The present invention is to provide an assembly device which controls transmission of data signals with or without using wires, wherein the assembly device is located between a control interface and an output module and utilizes a carrier wave of power line to transmit voltage signals and control signals.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a block diagram of the present invention.

FIG. 2 shows a schematic view of a first embodiment of the present invention.

FIG. 3 shows a schematic view of a second embodiment of the present invention.

### DETAILED DESCRIPTION OF THE PREFERRED EMBODIMENTS

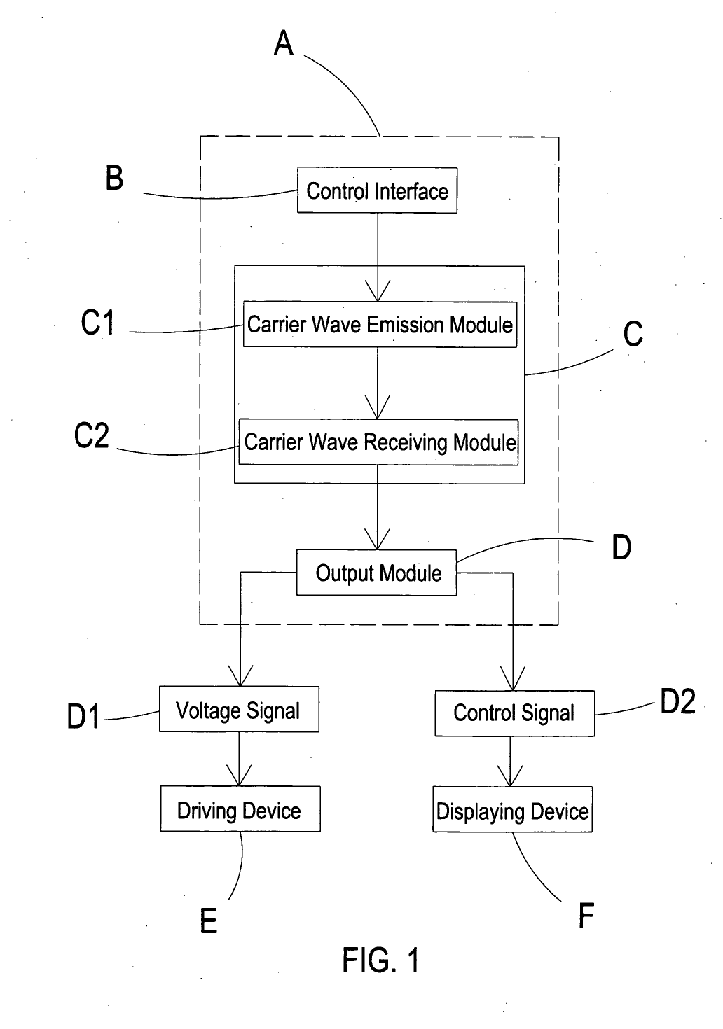

Referring to FIG. 1, the present invention is to provide an assembly device which controls transmission of data signals with or without using wires, wherein a data signal transmission assembly device A comprises primarily a control interface B, a carrier wave module C, and an output module D.

When the control interface B carries out a control operation, a control instruction is transmitted to a carrier wave emission interface C1 of the carrier wave module C, and the carrier wave emission interface C1 will transmit a signal to a carrier wave receiving module C2, enabling the carrier wave receiving module C2 to output a signal to the output module D which will output a voltage signal D1 to a driving device E, and a control signal D2 to a displaying device F. In addition, the control signal D2 of the output module D is corresponding to the control instruction that is transmitted by the control interface B.

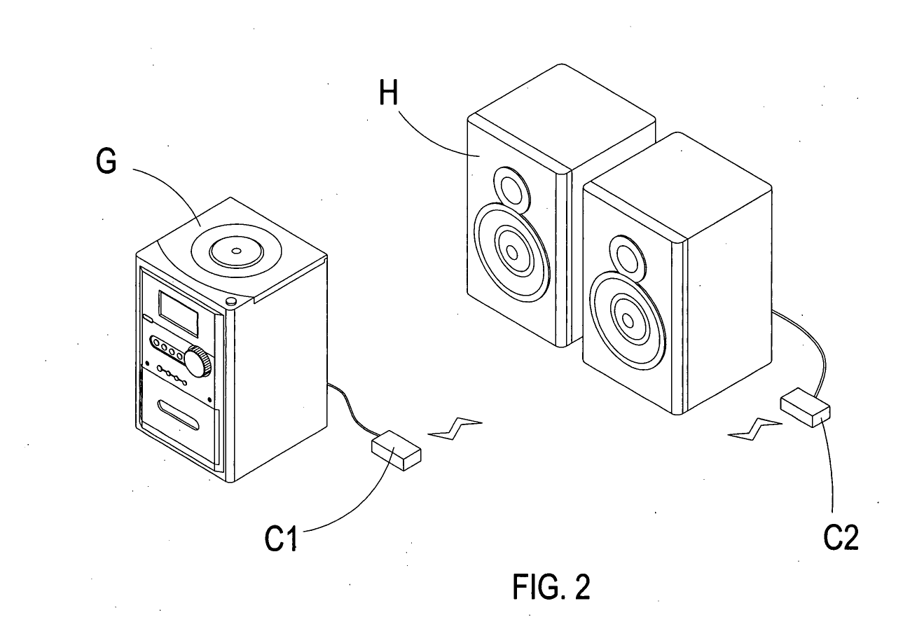

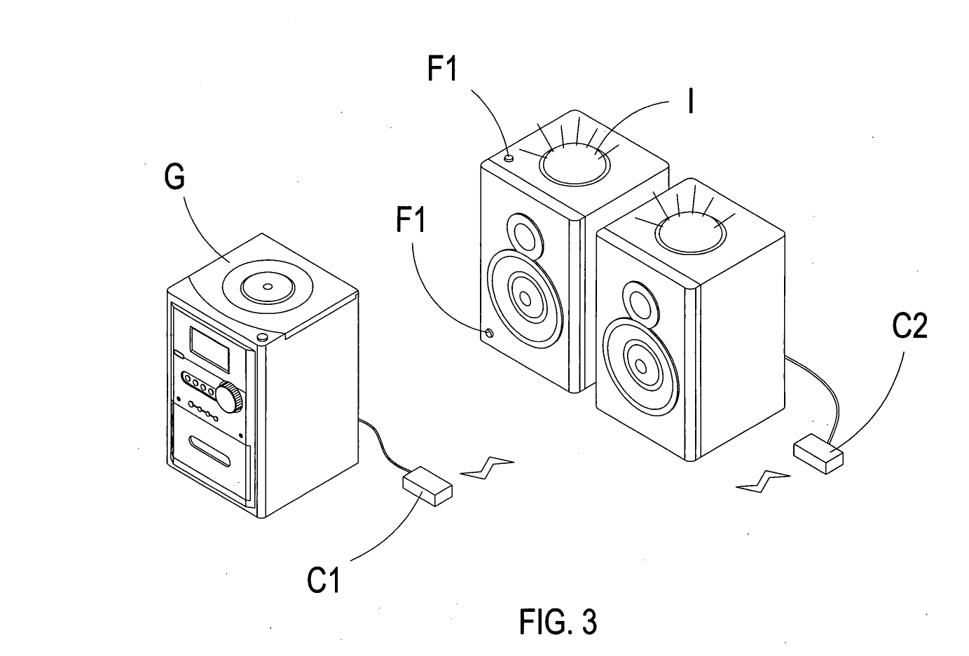

Referring to FIGS. 1 to 3, when the control interface B of the data signal transmission assembly device A carries out a control operation, by the carrier wave module C which is connected to the control interface B, the control instruction of the control interface B will be transmitted to the carrier wave emission interface C1 of the carrier wave module C, and the carrier wave emission interface C1 will transmit this control instruction to the carrier wave receiving interface C2. This control instruction is then outputted by the carrier wave receiving interface C2, and the carrier wave receiving interface C2 will output a signal to the output module D, such that the output module D can output a voltage signal D1 to the driving device E, and a control signal D2 to the displaying device F, thereby enabling the control interface B to achieve an effect of controlling the displaying device through the carrier wave module C.

The control interface B can be further a household appliance such as a stereo G or a TV (Television) set, the displaying device F can be further a household appliance which is provided with an output function and can be corresponding to the control interface, such as a speaker H or a light I, and the displaying device F can be even installed with an adjusting device F1 for adjusting output power of the displaying device F.

To further manifest the advancement and practicability of the present invention, the present invention is compared with a conventional assembly device as below:

Shortcomings of a conventional assembly device

1. The extra wiring is required.

2. The original beauty will be destroyed.

3. The wiring work is a troublesome and complicated project.

Advantages of the present invention

1. The extra wiring is not needed.

2. The power line is used as a transmission channel.

3. The original beauty can be preserved.

4. The troublesome and complicated wiring task will not be required.

5. It is provided with the advancement and practicability.

6. It is provided with the industrial competitiveness.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An assembly device which controls transmission of data signals with or without using wires, comprising a control interface, a carrier wave module, and an output module; the control interface operating and transmitting a control instruction to a carrier wave emission interface of the carrier wave module, and the carrier wave emission interface outputting a signal to a carrier wave receiving interface, enabling the carrier wave receiving interface to output a data signal to the output module which outputs a voltage signal to a driving device, and a control signal to a displaying device, such that by the wave carrier module, the data signals are transmitted without requiring deployment of an awkward wiring between the control interface and the displaying device.

2. The assembly device which controls transmission of data signals with or without using wires according to claim 1, wherein the displaying device is further installed with an adjusting device for adjusting output power of the displaying device.

3. The assembly device which controls transmission of data signals with or without using wires according to claim 1, wherein the control interface is further a household appliance including a stereo or a TV (Television) set.

4. The assembly device which controls transmission of data signals with or without using wires according to claim 1, wherein the driving device is further a motor control circuit, a voice control circuit, and other related device that is controlled by the voltage.

5. The assembly device which controls transmission of data signals with or without using wires according to claim 1, wherein the displaying device is further a household appliance which is provided with an output function and is corresponding to the control interface including a speaker or a light.
